(19) United States
(12) Patent Application Publication
(10) Pub. No.: US 2003/0019123 A1
(43) Pub. Date: Jan. 30, 2003

(54) Tape rule with improved structure of tape end

(75) Inventor: Henry Lin, Taipei (TW)

Correspondence Address: DOUGHERTY & TROXELL, ONE SKYLINE PLACE, SUITE 1404, 5205 LEESBURG PIKE, FALLS CHURCH, VA, 22041, US

(73) Assignee: INDEX MEASURING TAPE CO., LTD.

(21) Appl. No.: 09/916,309

(22) Filed: Jul. 30, 2001

(51) Int. Cl. G01B 3/10

(52) U.S. Cl. 33/758

(57) ABSTRACT

A tape rule with an improved structure at the end of metal tape. The tape hook is secured onto the end surface of metal tape by five rivets, and said rivets are arranged in a shape of English letter “T”, such that the security of tape and hook is enhanced.

### BACKGROUND OF THE INVENTION

1. Field of the Invention

The present invention relates to tape rules, especially to springpowered rewindable tape rules having an improved structure at the end of the tape, so as to enhance the reliability of tape rules.

2. Description of the Prior Art

The structure of the end of metal tape of conventional tape rules is shown in FIG. 1; at the end of the retractable metal tape 111, two rivet holes 121, 122 aligned on the tape retraction direction are formed on the tape 11; a hook 13 formed by a bended metal plate is secured to the end of the tape 11. Said book 13 includes a body portion 15 and a hook portion 14; on the body portion 15 of the hook 13, two holes 161, 162 corresponding to said two rivent holes 121, 122 are formed. Two rivets 171, 172 are firstly respectively put into a pair of said rivet hole 121 (122) formned on the tape 11 and hole 161 (162) formed on the body portion 15 of the hook 13, and then rivet to secure the hook 13 with the tape end firmly. However, since the retraction of metal tape into the casing of tape rule is stopped abruptly by the impact of the tape hook afainst the wall on the easing about the aperture formed in the casing for retraction and releasing of metal tapes. The hook 13 on the end of tape rule only can endure 3000˜4000 times' impact force generated in tape retraction. Therefore, the hook 13 is always lost and the tape rule become invalid.

### SUMMARY OF THE INVENTION

It is an object of present invention to provide a tape rule with improved structure of tape end in which the impact endurance of tape hook is enhanced.

It is also an object of present invention to provide a tape rule with improved structure of tape end in which the duration of tape rule is increased.

According to the tape rule with improved structure of tape end of present invention, the possibility of lost of tape hook is reduced and then the practicality of tape rule is also increased.

A more complete understanding of these and other features and advantages of the present invention will become apparent from a careful consideration of the following detailed description of certain embodiments illustrated in the following drawings.

### BRIEF DESCRIPTION OF THE DRAWINGS

FIG. 1 shows the structure of tape end conventional tape rules.

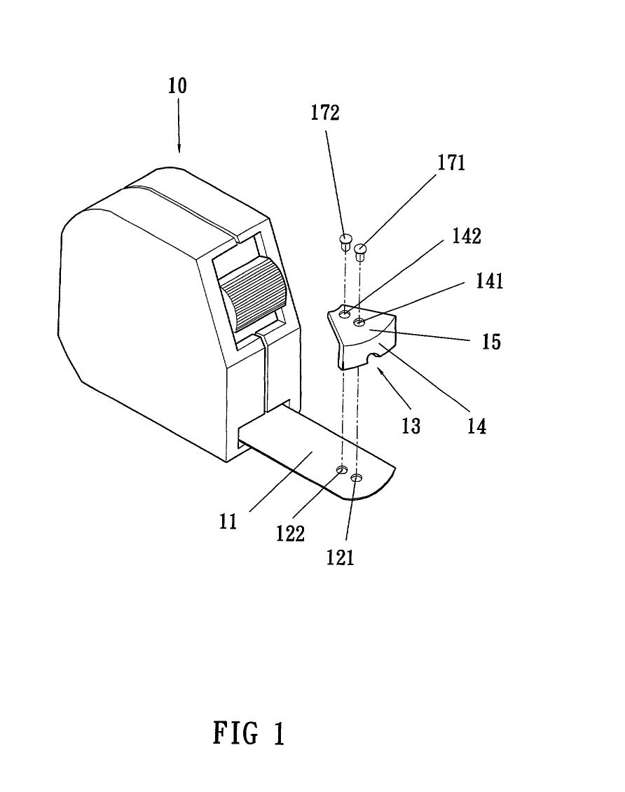

FIG. 2 shows the structure of tape end of the tape rule of present invention.

FIG. 3 is a cross-sectional view showing the construction of rivets with tape hook and metal tape.

### DETAILED DESCRIPTION OF THE PREFERRED EMBODIMENTS

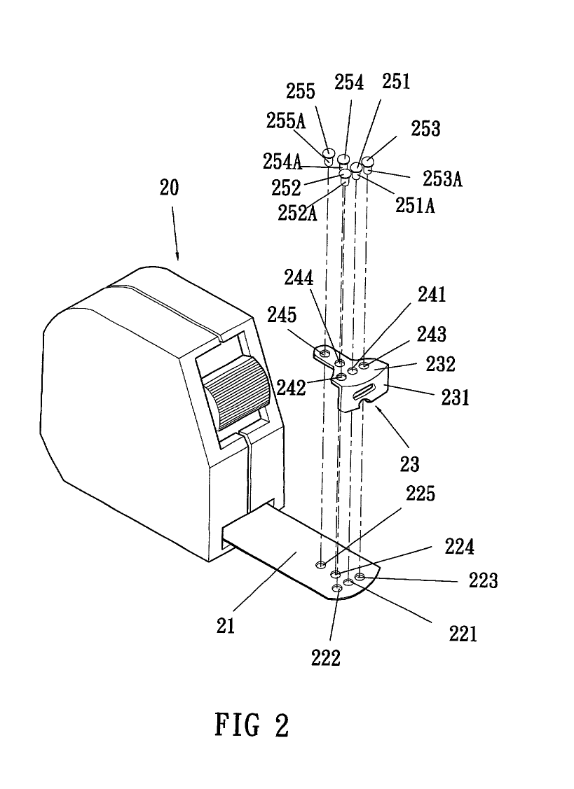

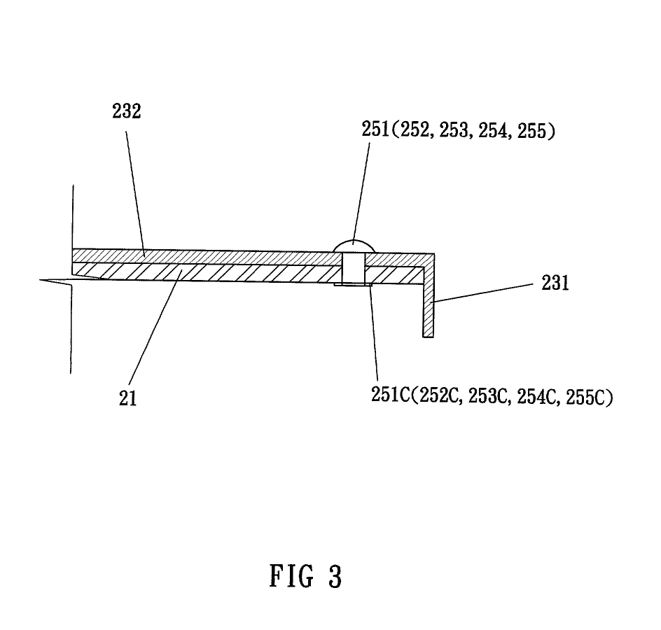

Referring to FIG. 2, the metal tape 21 of the tape rule 20 of present invention has five small holes 221, 222, 223, 224, 225 formed at the end of the metal tape 21; said five small holes are aligned both in longitudinal and perpendicular directions, such that said five small holes are arranged in “T” shape with each alignment having three small holes. A tape hook 23 is secured to the end of the metal tape 21; it also includes a body portion 231 and a hook portion 231 bended downward to the body portion 232. On the body portion 232 of the tape hook 23, there are five rivet holes 241, 242, 243, 244 245 corresponding and opposing to said five small holes 221, 222, 223, 224, 225 formed at the end of the metal tape 21. The widths of both body portion 232 and hook portion 231 of tape hook 23 are preferably not larger than that of metal tape 21, and the body portion 232 of tape hook 23 is preferably formed in T shape to match with the alignment of above-mentioned five small holes 221, 222, 223, 224, 225 formed at the end of the metal tape 21 and the five rivet holes 241, 242, 243, 244, 245 formed on the body portion 232 of the tape hook 23. Said tape hook 23 is secured to the metal tape 21 by passing the stem portions 251A, 252A, 253A, 254A, 255A of rivets 251, 252, 253, 254, 255 respectively through a pair of holes containing a small holes 221, 222, 223, 224, 225 rivets holes 241, 242, 243, 244, 245 mentioned above, and pressing the end of the stem portions 251A, 252A, 253A, 254A, 255A of said rivets 251, 252, 253, 254, 255 to form open rings 251C, 252C, 253C, 254C, 255C attached to the lower rim of said small holes 221, 222, 223, 224, 225 (as shown in FIG. 3).

Since the tape hook 23 is secured to the end of the metal tape 21 by five rivets 251, 252, 253, 254, 255 and the five rivets 251, 252, 253, 254, 255 aligned as a T shape character, that is, three rivets 251, 252, 253 are aligned in horizontal direction and three rivets 251, 254, 255 are aligned in longitudinal direction. Then, the tape hook 23 would secured much more firmly to the metal tape 21. The shearing strain between the tape hook 23 and the metal tape 21 generated due to the longitudinal impact force of hook portion 231 against the outer wall of casing about the tape retraction aperture would be distributed by said five rivets 251, 252, 253, 254, 255 preferably by three longitudinal three rivets 251, 254, 255, and then reduced; the torque which is generated during the time when the metal tape is retracted also would be distributed by said five rivets 251, 252, 253, 254, 255, preferably by the horizontal three rivets 251, 252, 253, and then reduced. The impact endurance of present invention would be increased to as three times of conventional tape rules.

Although the present invention has been described with a certain degree of particularity by six examples, the present disclosure has been made by way of example and changes in details of structure may be made without departing from the spirit thereof.

What is claimed is:

1. A tape rule with improved structure of tape end, claimed in that: a tape hook is secured onto the end surface of metal tape by five rivets, and said rivets are aligned in a shape of English letter T.

2. A tape rule with improved structure of tape end, as claimed in claim 1, wherein the body portion of said tape hook and the end portion of said metal respectively has five holes for said rivets to pass their stem portion through.

3. A tape rule with improved structure of tape end, as claimed in claim 1, wherein three rivets are aligned in the same direction.

4. A tape rule with improved structure of tape end, as claimed in claim 1, wherein three rivets are aligned in the longitudinal direction extend from the end of metal tape where the three rivets are aligned in the horizontal direction.

5. A tape rule with improved structure of tape end, as claimed in claim 2, wherein the lower end of the stem portion of every rivets pressed to form an open ring attached to the lower rim of said small holes formed on the metal tape.
